(19) United States
(12) Patent Application Publication
(10) Pub. No.: US 2004/0214708 A1
(43) Pub. Date: Oct. 28, 2004

(54) Method of, and folding machine for, folding a plurality of sheets in a buckle folder

(75) Inventors: Eberhard Krieger, Weinstadt-Struempfelbach (DE); Georg Dannemann, Backnang (DE); Klaus Stocklossa, Marbach (DE); Bodo Tegtmeier, Alfdorf-Pfahlbronn (DE)

Correspondence Address: ROTHWELL, FIGG, ERNST & MANBECK, P.C., 1425 K STREET, N.W., SUITE 800, WASHINGTON, DC, 20005, US

(73) Assignee: Maschinenbau Oppenweiler Binder GmbH & Co. KG, Oppenweiler (DE)

(21) Appl. No.: 10/834,046

(22) Filed: Apr. 29, 2004

(30) Foreign Application Priority Data
May 8, 2003 (EP) 03 010 426.9
Oct. 16, 2003 (EP) 03 023 584.0

(51) Int. Cl. B31F 7/00

(52) U.S. Cl. 493/419

(57) ABSTRACT

In the case of the method of, and the folding machine for, folding a plurality of sheets (50) in a buckle folder (12) with at least a first and a second buckle plate (30, 34, 70), in which a respective first sheet stop (32) and a second sheet stop (36, 72) are provided and between which at least one pair (41) of folding rollers, with folding rollers (40, 42) rotating in opposite directions, is arranged, the sheets (50) are transported one after the other into the first buckle plate (30) until they strike against the corresponding sheet stop (32), in which case they are collected in the first buckle plate (30) to form a group (51) of sheets. Then the group (51) of sheets is displaced in the direction of the pair (41) of folding rollers which follows the first buckle plate (30), as seen in the sheet-running direction, until it is gripped by the folding rollers (40, 42) thereof, and is then transported further, for folding purposes, in the second buckle plate (34, 70) until it strikes against the second sheet stop (36, 72).

### FIELD OF THE INVENTION

The invention relates to a method of folding a plurality of sheets in a buckle folder and to a folding machine having a buckle folder.

### DESCRIPTION OF THE BACKGROUND ART

German Utility Model 91 04 810.9 U1 discloses a folding machine which has a buckle folder with a plurality of buckle plates. Arranged upstream of the buckle folder is an aligning table, on which sheets which are removed from a sheet stack are aligned and transported to the buckle folder. Arranged above the aligning table is a multiple sheet sensor, which is designed such that it detects when sheets pass from the sheet feeder onto the transporting surface of the aligning table either one above the other or in an overlapping manner.

In the case of such a folding machine the sheets are removed one after the other from the sheet stack and transported to the buckle folder, in which they are folded individually one after the other.

In traditional book production, sheets are printed in sheet stacks and are processed further in sheet stacks. The operation of folding a first sheet stack is followed by the operation of folding a next sheet stack, which contains the next sheets in a number which likewise corresponds to the complete batch. In the folding machine, the individual sheet stacks are then processed successively. Thereafter, the folded sheets of a book are collated and bound on a gang stitcher or an adhesive binder.

If, however, the sheets are printed by a digital-printing machine, it is possible for all the sheets of a book to be successively printed and set down on a sheet stack. It is usually eight pages or sixteen pages of a book which are printed on the sheets.

### SUMMARY OF THE INVENTION

The object of the invention is to provide a method of folding a plurality of sheets and also a folding machine by means of which sheets which are produced by digital printing can be processed to form a book or a brochure with little design-related outlay and a high production capacity.

This object is achieved by a method of folding a plurality of sheets in a buckle folder having at least a first and a second buckle plate, in which a first sheet stop and a second sheet stop are provided, respectively, and between which at least one pair of folding rollers having folding rollers rotating in opposite directions is arranged, wherein said sheets are transported one after the other into said first buckle plate until they strike against said first sheet stop, said sheets are collected in said first buckle plate to form a group of sheets, and then said group of sheets is displaced in the direction of said pair of folding rollers which follows said first buckle plate, as seen in the sheet-running direction, until it is gripped by said folding rollers thereof and is then transported further, for folding purposes, into said second buckle plate until it strikes against said second sheet stop.

The method according to the invention and the folding machine according to the invention can be used to produce a complete book with different page numbers without the sheets having to be collated following passage through the folding machine. This increases the production capacity.

A folding machine for carrying out the method of the present invention comprises a buckle folder with at least a first and a second buckle plate, in which a respective first sheet stop and a second sheet stop are provided and between which at least one pair of folding rollers having folding rollers rotating in opposite directions is provided, wherein said first buckle plate comprises a displacing device which is controlled by a control device and by means of which a group of sheets collected in said first buckle plate is displaced in the direction of said pair of folding rollers which follows said first buckle plate, as seen in said sheet-running direction.

The sheets which are collected in the first buckle plate to form a group of sheets are preferably bound together by a binding device from above or from beneath along a folding line running transversely to the sheet-running direction, and around which the group of sheets is subsequently folded. Instead of the group of sheets, it is also possible for the binding device to bind an already folded sheet which is introduced individually into the buckle plate.

In the case of a preferred embodiment, the transported sheets can be identified by a detecting system, in which case, upon identification of a final sheet of a group of sheets, the transportation of a further sheet into the first buckle plate is delayed until the group of sheets has left the collecting pocket. For this purpose, an increase in the sheet spacing can be produced by a gap in the suction cycle of a suction wheel.

The detecting system can preferably be controlled by a control device such that the size of the group of sheets can be adjusted as the folding machine is processing.

In order to achieve precise alignment of the sheets which are collected from a group of sheets, there may be provided on the buckle plate an aligning device which has two side stops which are spaced apart opposite one another and of which at least one can be displaced transversely to the sheet-running direction in relation to the other by a drive or an elastic device.

### BRIEF DESCRIPTION OF THE DRAWINGS

An exemplary embodiment of the invention is explained in more detail hereinbelow with reference to drawings, in which:

FIG. 1 shows a first embodiment of a folding machine having a buckle folder,

FIG. 2 shows, schematically, the buckle folder of the folding machine from FIG. 1 prior to a sheet entering,

FIG. 3 shows the buckle folder from FIG. 2 once a plurality of sheets has entered into a first buckle plate,

FIG. 4 shows the buckle folder from FIG. 2 following displacement of a group of sheets,

FIG. 5 shows the buckle folder from FIG. 2 once the group of sheets has struck against a stop of a second buckle plate,

FIG. 6 shows the buckle folder from FIG. 2 once the group of sheets has been folded,

FIG. 7 shows a perspective view of the buckle folder from FIG. 2,

FIG. 8 shows, schematically, the buckle folder of a second embodiment of a folding machine prior to a sheet entering,

FIG. 9 shows the buckle folder from FIG. 8 once a plurality of sheets has entered into a first buckle plate,

FIG. 10 shows the buckle folder from FIG. 8 following displacement of a group of sheets,

FIG. 11 shows the buckle folder from FIG. 8 once the group of sheets has struck against a stop of a second buckle plate,

FIG. 12 shows the buckle folder from FIG. 8 once the group of sheets has been folded, and

FIG. 13 shows a perspective view of the buckle folder from FIG. 8.

### DETAILED DESCRIPTION OF THE INVENTION

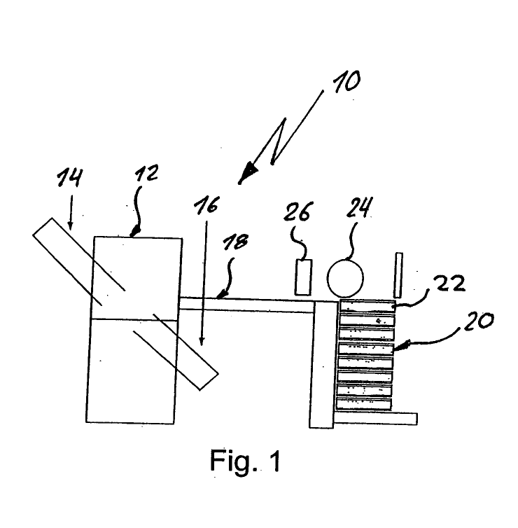

The folding machine 10, which is shown in FIG. 1, has a buckle folder 12 with a first buckle-plate device 14 and a second buckle-plate device 16. Provided upstream of the buckle folder 12, in a known manner, is an aligning table 18, by means of which sheets which are removed by a suction wheel 24 from the uppermost sheet stack 22 arranged on a sheet rest 20 are aligned and transported to the buckle folder 12. Adjacent to the suction wheel 24, a barcode reader 26 is arranged, as a detecting system, above the aligning table 18, this barcode reader being connected to a control device (not shown) to which it transmits a detection signal. A plurality of sheet stacks 22, which are each intended for processing a book, are arranged one above the other on the sheet rest 20. The individual, different sheets have been printed by a digital printer and set down on the sheet stack 22 in a predetermined sequence.

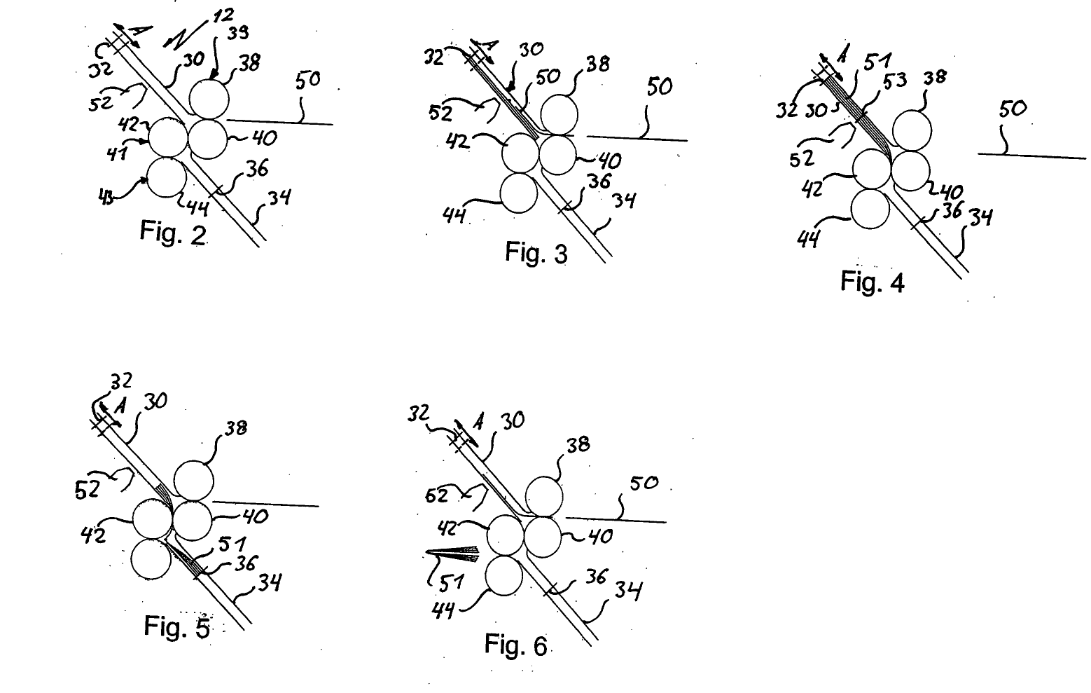

As shown in FIG. 2, the buckle folder 12 has a first, obliquely upwardly extending buckle plate 30 and a second buckle plate 34, which extends obliquely downward in the opposite direction, the two buckle plates being arranged, in a known manner, parallel to one another and with inclination at the same angle. Provided upstream of the mouth opening of the first buckle plate 30 is a first, vertical pair 39 of folding rollers, with a top folding roller 38 and a bottom folding roller 40. A second, horizontal pair 41 of folding rollers is formed by the folding roller 40 and a folding roller 42, the nip between the folding rollers 40, 42 being located adjacent to the mouth openings of the first buckle plate 30 and of the second buckle plate 34. Finally, the folding roller 42, along with a folding roller 44, forms a third, vertically arranged pair 43 of folding rollers adjacent to the mouth opening of the second buckle plate 34.

The first buckle plate 30 contains a sheet stop 32, which can be displaced in the longitudinal direction of the first buckle plate 30, in the direction of the double arrow of the case A, by a drive (not shown), the drive being controlled by the control device.

Provided beneath the buckle plate 30 is a binding device, which has two or more binding heads 52 (only one is shown) which are spaced apart from one another level with a folding line 37 along which sheets entering into the buckle plate 30 are subsequently folded.

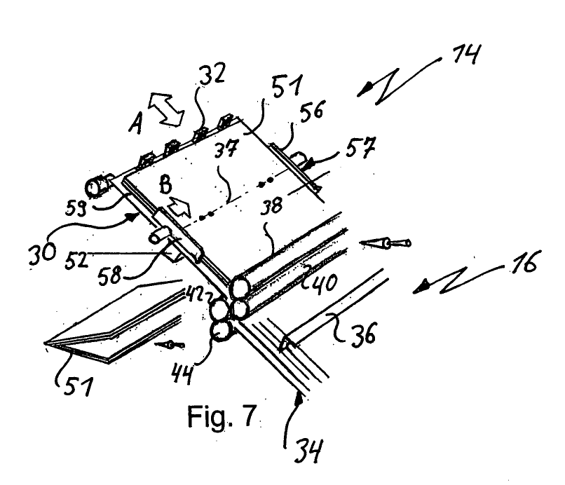

As is shown in FIG. 7, an aligning device 57 is provided on the first buckle plate 30, this aligning device having two strip-like side stops 56, 58 which are spaced apart from one another transversely to the sheet-running direction and extend above the sheet rest 59 of the buckle plate 30 in the sheet-running direction. The right-hand side stop 56 in FIG. 7 is fixed, whereas the left-hand side stop 58 can be moved transversely to the sheet-running direction, in the direction of the arrow B, by means of a, for example, pneumatic drive (not shown).

FIG. 2 shows the buckle folder 12 prior to a sheet 50 entering, this sheet being conveyed by the aligning device 18 to the nip between the folding rollers 38, 40 of the first pair 39 of folding rollers. As soon as the sheet 50 is gripped by the folding rollers 38, 40, the sheet 50 is conveyed into the first buckle plate 30 between the side stops 56, 58 until it strikes against the sheet stop 32 (see FIG. 3). At this point in time, the sheet stop 32, as can be seen in FIG. 2, is adjusted by the drive such that the sheet edge which is directed away from the sheet stop 32 is spaced apart from the nip between the folding rollers 40, 42 of the second pair 41 of folding rollers when the sheets 50 have struck against the stop 32.

As shown in FIG. 3, a plurality of sheets 50 are conveyed one after the other into the first buckle plate 30, serving as a collecting pocket, until a group 51 of sheets (FIG. 4), with a certain number of sheets 50 located one above the other, has been formed in the first buckle plate 30. Once the final sheet 50 of the group 51 of sheets has entered, the side stop 58 is displaced, for lateral alignment of the group 51 of sheets, in the direction of the side stop 56 until the group 51 of sheets butts against the side stop 56. The group 51 of sheets is then bound by the binding head 52 along the folding line 37, around which the group 51 of sheets is subsequently folded, U-shaped staples 53 being driven through the group 51 of sheets from beneath at a distance apart from one another. A counter-plate (not shown) is arranged on that side of the group 51 of sheets which is opposite to the binding head 52, the free ends of the staples 53, which project beyond the group 51 of sheets, being bent over in a known manner by said counter-plate.

The stop 32 of the first buckle plate 30 is then moved in the direction of the second pair 41 of folding rollers, as a result of which the group 51 of sheets is displaced until those edges of the sheets 50 of the group 51 which are directed away from the stop 32 are gripped by the folding rollers 40, 42 and conveyed into the second buckle plate 34. This position is shown in FIG. 5. As soon as the group 51 of sheets has left the first buckle plate 30, a sheet 52 for a further group 51 of sheets can be introduced into the first buckle plate 30. The stop 32 is then moved into its starting position again. Once the sheets 50 of the group 51 of sheets have come into contact with the stop 36 in the second buckle plate 34, the group 51 of sheets is buckled since the trailing end of the group 51 of sheets continues to be transported by the folding rollers 40, 42. This results in a folding edge forming in the sheet stack 51 along the folding line 37, on which the staples 53 are fastened, and the folding edge is gripped by the folding rollers 42, 44 of the third pair 41 of folding rollers, as a result of which the sheet stack 51 is folded transversely to its running direction and leaves the third pair 43 of folding rollers, as shown in FIG. 6. The crosspiece of the staple 53, in the folded sheet stack 51, bears against the folding edge on the outside.

A barcode is provided on the sheet 50 of a group 51 of sheets which is the final sheet to enter. When the barcode reader 26 detects this barcode, it transmits a corresponding signal to the control device, which then delays the removal of the next sheet from the sheet stack 22 by the suction wheel 24 until it is ensured that the sheet stack 51 has left the first buckle plate 30 before the next sheet 52 for a further group of sheets is introduced into the first buckle plate 30.

Such a detecting system also makes it possible for the size of each group of sheets to be adjusted by means of the control device.

In the simplest form, the detecting system may also be formed by a light barrier which is connected to a control unit which comprises a counting device.

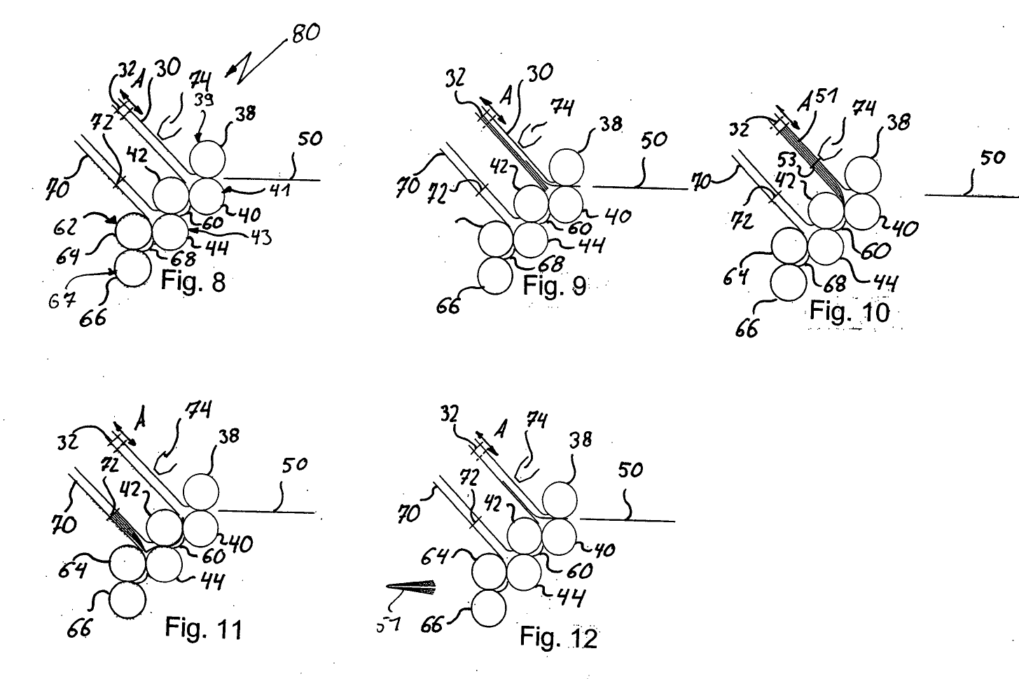

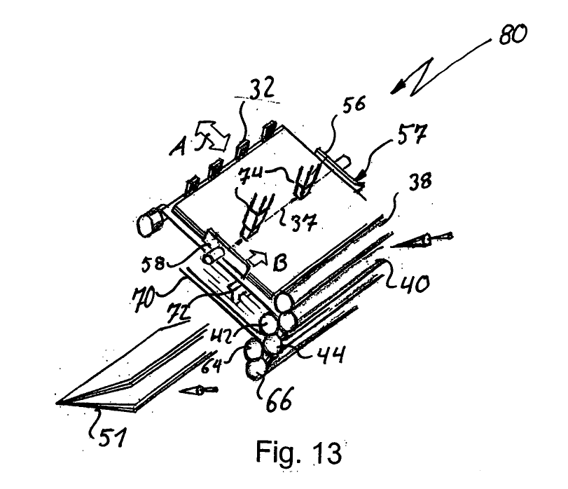

The buckle folder 80 of the second embodiment of a folding machine, which is shown in FIGS. 8 to 13, differs from the buckle folder 12 of the embodiment which has been described in FIGS. 2 to 7, first of all, in that the binding heads 74, in this embodiment, are arranged above the buckle plate 30. Arranged in the region beneath the nip between the folding rollers 40, 42, instead of the second buckle plate 34, is a deflecting element 60, by means of which the group 51 of sheets passing out of the buckle plate 30 is deflected into the nip between the folding rollers 42, 44. The mouth opening of a second buckle plate 70 is arranged on that side of the nip between the folding rollers 42, 44 which is opposite to the deflecting element 60, the second buckle plate 70 running parallel to the first buckle plate 30. Arranged adjacent to the mouth opening of the second buckle plate 70 is a further horizontal pair 62 of folding rollers, this pair being formed by the folding roller 44 and a further folding roller 64. The pair 62 of folding rollers is followed by a further vertical pair 67 of folding rollers, this pair being formed by the folding roller 64 and a further folding roller 66. A further deflecting element 68 is arranged between the nips of the pair 62 of folding rollers and the pair 67 of folding rollers.

The method steps which are shown in FIGS. 8 to 10 correspond to the method steps which are shown in FIGS. 2 to 4. The single difference is that the group 51 of sheets is bound by the binding heads 74 from above, with the result that the U-shaped staples 53 are driven through the group 51 of sheets from above at a distance apart from one another. It is also the case with this embodiment that a counter-plate (not shown) is arranged on that side of the group 51 of sheets which is opposite to the binding heads 74, the free ends of the staples 53, which extend beyond the group 51 of sheets, being bent over in a known manner by said counter-plate.

Following the binding operation, the stop 32 of the first buckle plate 30 is moved in the direction of the second pair 41 of folding rollers, as a result of which the group 51 of sheets is displaced until those edges of the sheets 50 of the group 51 which are directed away from the stop 32 are gripped by the folding rollers 40, 42 (FIG. 10). The group of sheets is guided, along the deflecting element 60, into the nip between the folding rollers 42, 44, and is gripped by the folding rollers 42, 44 and conveyed into the second buckle plate 70. As can be seen in FIG. 11, once it has come into contact with the stop 72 in the second buckle plate 70, the group 51 of sheets is buckled since the trailing end of the group 51 of sheets continues to be transported by the folding rollers 42, 44. This results in a folding edge forming in the sheet stack 51 along the folding line 37, on which the staples 53 are fastened. The folding edge is gripped by the folding rollers 44, 64, as a result of which the sheet stack 51 is folded transversely to its running direction. Following the folding rollers 44, 64, the sheet is deflected, by the deflecting element 68, into the nip between the folding rollers 64, 66 and gripped by the folding rollers 64, 66. The group 51 of sheets then leaves the final pair 67 of folding rollers, as is shown in FIG. 12.

Although the sheet stack 51 is bound from above in the first folder in the case of the embodiment shown in FIGS. 8 to 13, it is also the case here that the crosspiece of the staples 53, in the folded sheet stack 51, bears against the folding edge on the outside.

In the case of the methods described, in each case the sheets, in the first instance, are collected in the first buckle plate 30 to form a group 51 of sheets, and the group 51 of sheets is bound and then folded. By means of the buckle folders 12, 80 described, however, it is also possible, instead of a plurality of individual sheets 50, for an already folded sheet to be introduced into the first buckle plate, bound, guided out of the buckle plate and then folded.

What is claimed:

1. A method of folding a plurality of sheets in a buckle folder having at least a first and a second buckle plate, in which a first sheet stop and a second sheet stop are provided, respectively, and between which at least one pair of folding rollers having folding rollers rotating in opposite directions is arranged, wherein said sheets are transported one after the other into said first buckle plate until they strike against said first sheet stop, said sheets are collected in said first buckle plate to form a group of sheets, and then said group of sheets is displaced in the direction of said pair of folding rollers which follows said first buckle plate, as seen in the sheet-running direction, until it is gripped by said folding rollers thereof and is then transported further, for folding purposes, into said second buckle plate until it strikes against said second sheet stop.

2. The method as claimed in claim 1, wherein said sheets which are collected in said first buckle plate to form a group of sheets are bound together along a folding line running transversely to said sheet-running direction.

3. The method as claimed in claim 1, wherein subsequently to said pair of folding rollers gripping said group of sheets, said group of sheets is deflected and is then transported into said second buckle plate by a further pair of folding rollers.

4. The method as claimed in claim 1, wherein said transported sheets are identified by a detecting system, whereby upon identification of a final sheet which is to be collected in a group sheets, said transportation of a further sheet into said first buckle plate is delayed until said group of sheets has left said first buckle plate.

5. A folding machine having a buckle folder with at least a first and a second buckle plate, in which a respective first sheet stop and a second sheet stop are provided and between which at least one pair of folding rollers having folding rollers rotating in opposite directions is provided, wherein said first buckle plate comprises a displacing device which is controlled by a control device and by means of which a group of sheets collected in said first buckle plate is displaced in the direction of said pair of folding rollers which follows said first buckle plate, as seen in said sheet-running direction.

6. The folding machine as claimed in claim 5, wherein said displacing device is formed by said first sheet stop, said first sheet stop being displacable in a longitudinal direction of said first buckle plate by means of a drive.

7. The folding machine as claimed in claim 5, wherein arranged upstream of said buckle folder, as seen in said sheet-running direction, is a sheet-feeding means for feeding sheets from a sheet stack to said buckle folder, said sheet-feeding means being assigned a detecting system which is intended for identifying fed sheets and is connected to said control device, which controls said sheet-feeding means such that, when a certain sheet is identified by said detecting system, the feed of a further sheet is delayed.

8. The folding machine as claimed in claim 5, wherein provided on said first buckle plate is a binding device by means of which said group of sheets is bound together along a folding line running transversely to said sheet-running direction.

9. The folding machine as claimed in claim 8, wherein said binding device is arranged and designed such that a staple is driven through said group of sheets from above.

10. The folding machine as claimed in claim 8, wherein said binding device is arranged and designed such that a staple is driven through said group of sheets from beneath.

11. The folding machine as claim 5, wherein arranged on said first buckle plate is an aligning device for the lateral alignment of sheets which enter into said first buckle plate, said aligning device having two side stops which are spaced apart opposite one another and of which at least one can be displaced transversely to said sheet-running direction in relation to the other.

12. The folding machine as claimed in claim 12, wherein said displaceable side stop is driven by a drive.

13. The folding machine as claimed in claim 12, wherein said displaceable side stop can be displaced counter to the force of an elastic device.
